(19) United States
(12) Patent Application Publication
(10) Pub. No.: US 2025/0276460 A1
(43) Pub. Date: Sep. 4, 2025

(54) MODULAR PERSONAL CARE IMPLEMENT

(71) Applicant: The Gillette Company LLC, Boston, MA (US)

(72) Inventors: Viktor Kraft, Wiesbaden (DE); Rory Frederick Wellington McGarry, Boston, MA (US); Brian Patrick Watson, Marshfield, MA (US); Gerald Goerich, Weiterstadt (DE); Nicolas Götz, Ober-Ramstadt (DE); Sven Mueller, Kronberg im Taunus (DE)

(21) Appl. No.: 18/591,741

(22) Filed: Feb. 29, 2024

(51) Int. Cl. B26B 21/08; B26B 21/52

(52) U.S. Cl. CPC B26B 21/08; B26B 21/521

(57) ABSTRACT

A modular personal care implement including a surface treatment head having a first end with an applicator and a second end with a first detachable connector; and a first interconnector having a first end with a second detachable connector and a second end with a third detachable connector, in which the second detachable connector is removably attached to the first detachable connector of the surface treatment head. Also provided are a method of providing a modular personal care implement and a kit including a modular personal care implement.

### FIELD OF THE INVENTION

The disclosure generally relates to a modular personal care implement, and more particularly to a modular personal care implement having a surface treatment head and at least one interconnector.

### BACKGROUND OF THE INVENTION

Handles for personal care devices, such as toothbrushes and razors, are typically made from multiple components. These may include weighted components to give the razor a more substantial feel in the user's hand and various gripping areas so the personal care device does not slip out of the user's hand in a wet environment. These component parts are in addition to the cartridge connection, which may be formed as an integral part of the handle or may be formed separately and attached to the remainder of the handle.

Personal care device manufacturers have developed numerous assembly methods utilizing various handle components. Numerous different methods and styles of handles may be used in order to stratify the appeal of a growing population of diverse consumers. Numerous different assembly methods and components for different handle designs can be costly and time consuming to develop. In addition, consumers typically change their handle as new designs are released to the market. Accordingly, it would be desirable to provide a personal care implement that can be customized to accommodate the preferences of different users.

### SUMMARY OF THE INVENTION

In accordance with an aspect of the present disclosure, a modular personal care implement is provided that includes a surface treatment head having a first end with an applicator and a second end with a first detachable connector; and a first interconnector having a first end with a second detachable connector and a second end having a third detachable connector, in which the second detachable connector is removably attached to the first detachable connector of the surface treatment head.

In accordance with another aspect of the present disclosure, a method of providing a modular personal care implement is provided, in which the method includes: providing one or more surface treatment heads each having a first end with an applicator and a second end with a first detachable connector; providing a plurality of first interconnectors each having a first end with a second detachable connector and a second end having a third detachable connector; providing a plurality of second interconnectors each having a first end with a fourth detachable connector and a second end having a fifth detachable connector; providing one or more end interconnectors each having a first end with a sixth detachable connector; and removably attaching the second detachable connector of one first interconnector of the plurality of first interconnectors to the first detachable connector of one surface treatment head of the one or more surface treatment heads.

In accordance with a further aspect of the present disclosure, a kit is provided that includes a first surface treatment head having a shaving razor cartridge, the first surface treatment head having a first end with an applicator and a second end with a first detachable connector, in which the applicator includes at least one blade; at least one first interconnector having a first end with a second detachable connector and a second end having a third detachable connector; at least one end interconnector having a first end with a fourth detachable connector; a case including a top portion and a bottom portion; and an insert including one or more cavities configured to receive the first surface treatment head, first interconnector, and end interconnector, in which the bottom portion of the case defines a compartment configured to removably receive the insert within the bottom portion.

### BRIEF DESCRIPTION OF THE DRAWINGS

While the specification concludes with claims particularly pointing out and distinctly claiming the subject matter which is regarded as forming the present invention, it is believed that the invention will be better understood from the following description which is taken in conjunction with the accompanying drawings in which like designations are used to designate substantially identical elements, and in which:

FIG. 1A is a perspective view of a modular personal care implement, in accordance with the present disclosure.

FIG. 1B is a bottom view of a modular personal care implement, in accordance with the present disclosure.

FIG. 2 is an exploded view of a modular personal care implement, in accordance with the present disclosure.

FIG. 3 is a cross-sectional view taken along line 3-3 in FIG. 2.

FIG. 4A is an end view taken along view line 4A-4A in FIG. 2.

FIG. 4B is an end view taken along view line 4B-4B in FIG. 2.

FIG. 5A is an end view taken along view line 5A-5A in FIG. 2.

FIG. 5B is a cross-sectional view taken along line 5B-5B in FIG. 2.

FIG. 6A is an end view taken along view line 6A-6A in FIG. 2.

FIG. 6B is an end view taken along view line 6B-6B in FIG. 2.

FIG. 7A is an end view taken along view line 7A-7A in FIG. 2.

FIG. 7B is an end view taken along view line 7B-7B in FIG. 2.

FIG. 8 is an exploded view of a modular personal care implement, in accordance with the present disclosure.

FIG. 9 is a cross-sectional view taken along line 9-9 in FIG. 8.

FIG. 10 is an exploded view of a modular personal care implement, in accordance with the present disclosure.

FIG. 11 is a cross-sectional view taken along line 11-11 in FIG. 10.

FIG. 12 is a perspective view of a kit comprising a modular personal care implement, in accordance with the present disclosure.

FIG. 13 is a flow diagram of a method of providing a modular personal care implement, in accordance with the present disclosure.

### DETAILED DESCRIPTION OF THE INVENTION

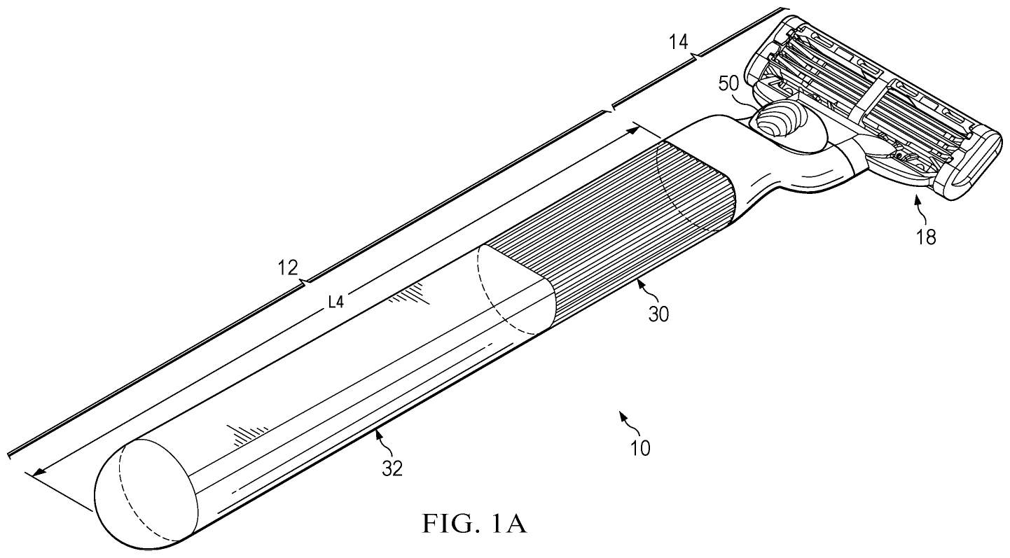

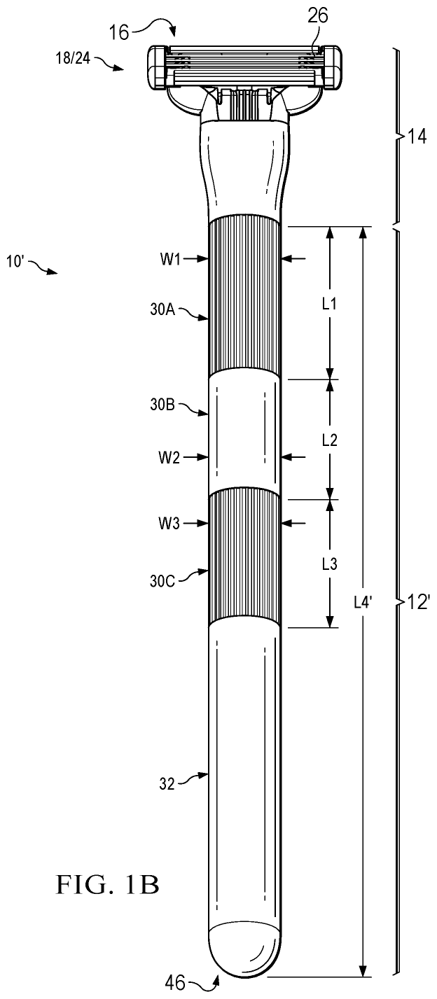

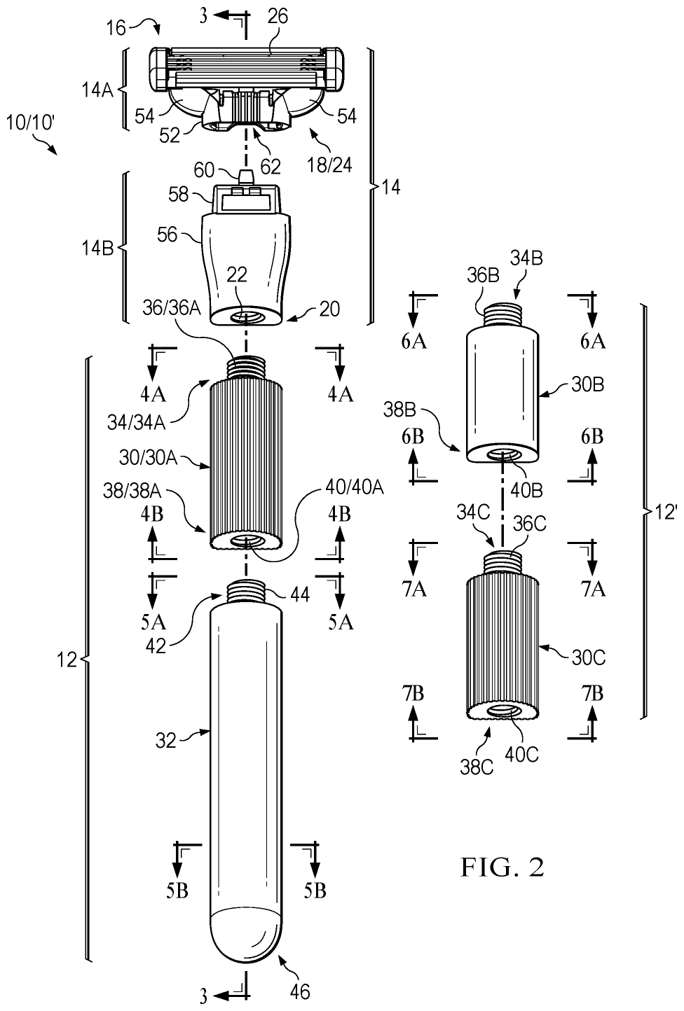

With reference to FIGS. 1A, 2, and 3, a modular personal care implement 10 in accordance with the present disclosure is illustrated, in which the modular personal care implement 10 depicted in FIG. 1A comprises the components shown on the left side of FIG. 2. The modular personal care implement 10 comprises a handle section 12 and a surface treatment head 14. The modular personal care implement 10 may be a handheld personal grooming implement, such as a shaving razor, a toothbrush, and the like.

The surface treatment head 14 has a first end 16 with an applicator 18, and a second end 20 with a first detachable connector 22. The surface treatment head 14 may comprise a first portion 14A that includes the applicator 18, and a second portion 14B that includes the first detachable connector 22. The surface treatment head 14 may further comprise a release mechanism positioned between the first and second ends 16 and 20, i.e., between the first and second portions 14A and 14B. The release mechanism may comprise an actuator button 50 configured to eject the first portion 14A comprising the applicator 18 from the second portion 14B comprising the first detachable connector 22.

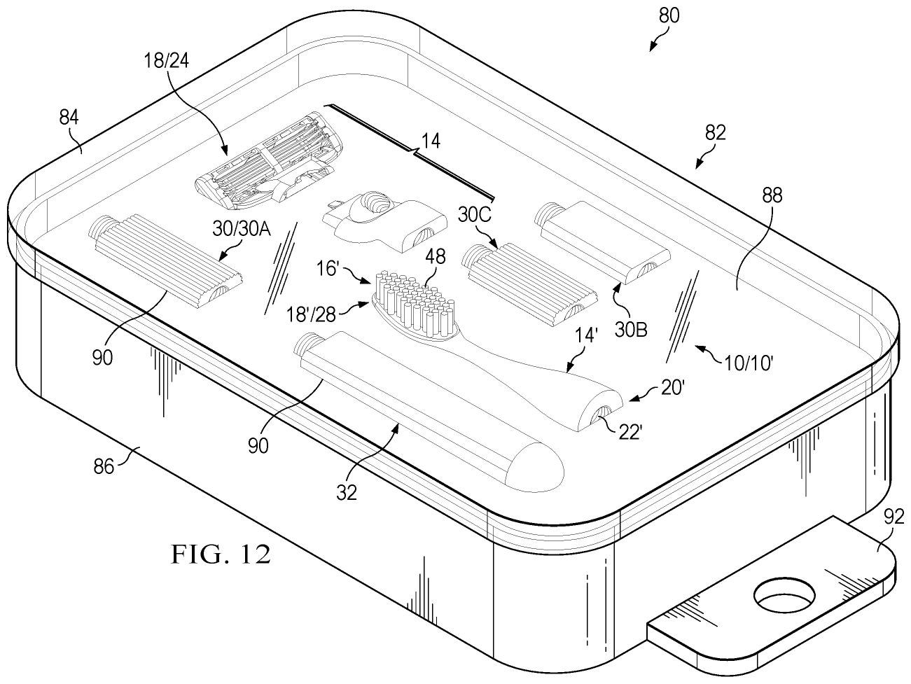

With reference to FIG. 2, the first portion 14A of the surface treatment head 14 may comprise a shaving razor cartridge 24, and the applicator 18 may comprise at least one blade 26. The shaving razor cartridge 24 may comprise a base 52 with two arms 54 that pivotally support a housing (not separately labeled), in which the housing includes the at least one blade 26. The second portion 14B of the surface treatment head 14 may comprise a cartridge support structure 56 with an extension 58 and a spring-biased plunger 60. The base 52 of the shaving razor cartridge 24 includes a cavity 62 that is configured to receive the extension 58 and the spring-biased plunger 60. The actuator button 50 may be moved toward the shaving razor cartridge 24, and the spring-biased plunger 60 causes the shaving razor cartridge 24 to be ejected from the cartridge support structure 56. Although the surface treatment head 14 is depicted as a shaving razor cartridge 24, it is understood that it may alternatively be a brush head having bristles, e.g., a toothbrush (not shown in FIG. 2; see FIG. 12) or other personal grooming or hygiene product.

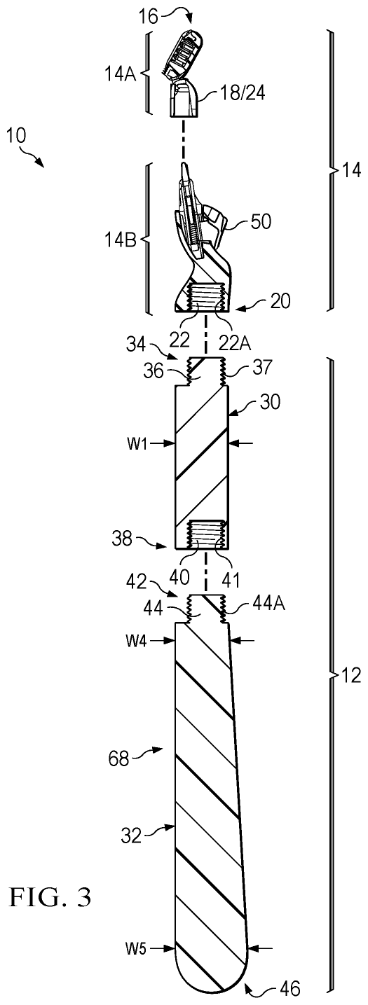

As shown in FIGS. 2 and 3, the handle section 12 of the modular personal care implement 10 comprises a first interconnector 30 and an end interconnector 32. The first interconnector 30 has a first end 34 with a second detachable connector 36, and a second end 38 with a third detachable connector 40. The second detachable connector 36 is removably attached to the first detachable connector 22 of the surface treatment head 14, as described herein. The end interconnector 32 has a first end 42 with a fourth detachable connector 44, in which the fourth detachable connector 44 is removably attached to the third detachable connector 40 of the first interconnector 30, as described herein. A second end 46 of the end interconnector 32 may define a terminus or terminal end of the handle section 12.

In the example shown in FIGS. 2 and 3, the first detachable connector 22 of the surface treatment head 14, the second and third detachable connectors 36 and 40 of the first interconnector 30, and the fourth detachable connector 44 of the end interconnector 32 may each comprise a mechanical connection in the form of a threaded connection. The second detachable connector 36 of the first interconnector 30 comprises external threads 37, and the first detachable connector 22 of the surface treatment head 14 comprises corresponding internal threads 22A that receive the external threads 37 to securely and removably attach the second detachable connector 36 to the first detachable connector 22 and removably attach the surface treatment head 14 to the first interconnector 30. The fourth detachable connector 44 of the end interconnector 32 likewise comprises external threads 44A, and the third detachable connector 40 of the first interconnector 30 comprises corresponding internal threads 41 that receive the external threads 44A to securely and removably attach the fourth detachable connector 44 to the third detachable connector 40 and removably attach the first interconnector 30 to the end interconnector 32. The surface treatment head 14, the first interconnector 30, and/or the end interconnector 32 may be detached by unscrewing from the adjacent component. As used herein, the term “removably attach” and similar terms are intended to refer to a connection or coupling that is configured to be formed repeatedly by a consumer attaching and detaching components under normal use conditions without causing damage to the components.

FIGS. 1B, 2, and 12 illustrate another example of a modular personal care implement 10′ in accordance with the present disclosure. The modular personal care implement 10′ depicted in FIG. 2 includes all of the components shown in FIG. 2 and is depicted as part of a kit 80 in FIG. 12, as described herein in more detail. The modular personal care implement 10′ comprises a handle section 12′ and a surface treatment head 14, in which the handle section 12′ comprises a first interconnector 30A, at least one second interconnector 30B and/or 30C, and an end interconnector 32. While the illustrated example includes two second interconnectors 30A and 30B, it may be understood that the modular personal care implement 10′ may include one second interconnector, three second interconnectors, four second interconnectors, etc. depending on the desired style, design, and/or length of the handle section 12′.

With reference to FIGS. 1B and 2, the first interconnector 30A, which may be identical or substantially similar to the first interconnector 30 described with respect to FIG. 1A, has a first end 34A with a second detachable connector 36A and a second end 38A with a third detachable connector 40A. The second interconnectors 30B and 30C each have a respective first end 34B and 34C with a fourth detachable connector 36B and 36C, and a respective second end 38B and 38C with a fifth detachable connector 40B and 40C. The end interconnector 32 may be identical or substantially similar to the end interconnector 32 described with respect to FIG. 1A, in which the detachable connector 44 at the first end 42 of the end interconnector 32 may be referred to as a sixth detachable connector 44.

The first detachable connector 22 of the surface treatment head 14, the second and third detachable connectors 36A and 40A of the first interconnector 30A, the fourth and fifth detachable connectors 36B, 36C, 40B, and 40C of the second interconnectors 30B and 30C, and the sixth detachable connector 44 of the end interconnector 32 forming the modular personal care implement 10′ shown in FIGS. 1B and 2 may each comprise a mechanical connection in the form of a threaded connection, as described above with respect to FIG. 3. To form the modular personal care implement 10′ depicted in FIG. 1B, the second detachable connector 36A of the first interconnector 30A is removably attached to the first detachable connector 22 of the surface treatment head 14; the third detachable connector 40A of the first interconnector 30A is removably attached to the fourth detachable connector 36B at the first end 34B of the second interconnector 30B; the fifth detachable connector 40B at the second end 38B of the second interconnector 30B is removably attached to the fourth detachable connector 36C at the first end 34C of the second interconnector 30C; and the fifth detachable connector 40C at the second end 38C of the second interconnector 30C is removably attached to the sixth detachable connector 44 of the end interconnector 32. The second end 46 of the end interconnector 32 may define a terminus or terminal end of the handle section 12′

The surface treatment head 14 shown in FIGS. 1B and 12 may be a shaving razor cartridge 24 that may be identical or substantially similar to the shaving razor cartridge 24 described with respect to FIG. 1A, in which the applicator 18 comprises at least one blade 26. In the example shown in FIG. 12, a second surface treatment head 14′ may comprise a first end 16′ with an applicator 18′ and a second end 20′ with a first detachable connector 22′ that may be substantially similar to the first detachable connector 22 of the surface treatment head 14 comprising the shaving razor cartridge 24. The second surface treatment head 14′ may comprise a brush head 28, e.g., a toothbrush, and the applicator 18′ comprises a plurality of bristles 48. The second surface treatment head 14′ may be included in place of, or in addition to, the surface treatment head 14 comprising the shaving razor cartridge 24. In the example shown in FIG. 12, the first detachable connector 22′ may comprise internal threads (not labeled) that are configured to receive the external threads 37 (see FIGS. 2 and 3) of the second detachable connector 36 of the first interconnector 30 to securely and removably attach the second detachable connector 36 to the first detachable connector 22′ and removably attach the surface treatment head 14′ to the first interconnector 30.

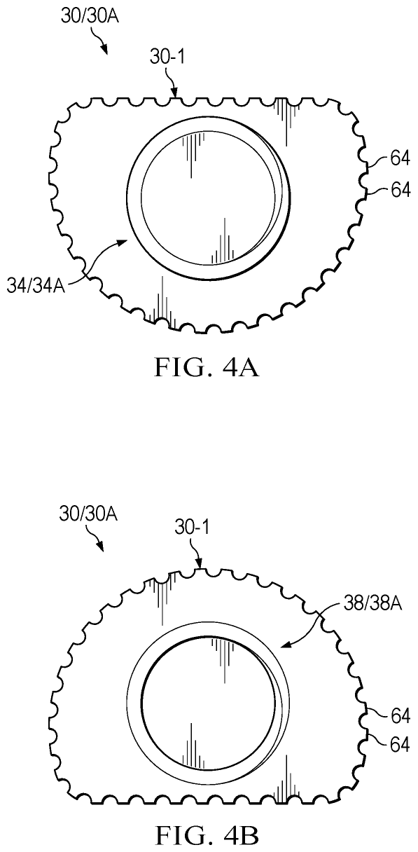

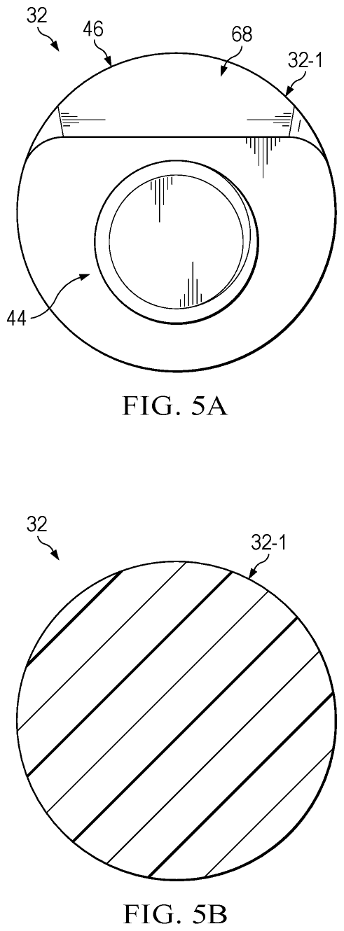

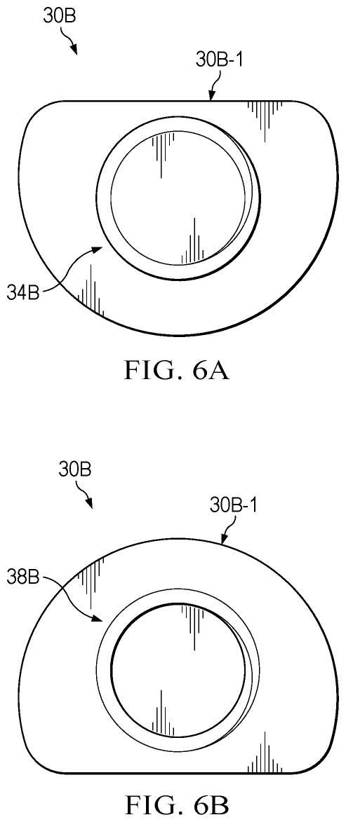

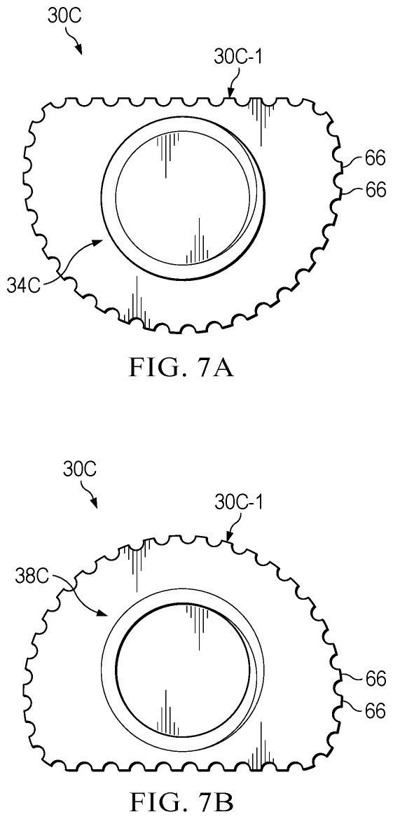

As shown in FIGS. 4A, 4B, 5A, and 5B, an outer surface 30-1 of the first interconnector 30/30A may comprise a plurality of gripping protrusions 64, and an outer surface 32-1 of the end interconnector 32 may be smooth. As shown in FIGS. 6A, 6B, 7A, and 7B, an outer surface 30B-1 of the second interconnector 30B may be smooth, and an outer surface 30C-1 of the second interconnector 30C may comprise a plurality of gripping protrusions 66 similar to the gripping protrusions 64 of the first interconnector 30/30A. Although not shown, it may be understood that the outer surfaces 30B-1 and 30C-1 of the second interconnectors 30B and 30C may both have gripping protrusions or may both be smooth. The gripping protrusions 64 and 66 of the first interconnector 30/30A and the second interconnector 30C may assist with gripping the modular personal care implement 10, 10′ in a wet environment. A number and/or location of the components having gripping protrusions 64, 66 may be adjusted and customized as desired based on user preference, e.g., how the user grips the handle section 12 and 12′, a size of the user's hand, etc.

The first and second interconnectors 30/30A, 30B, and 30C may comprise one or more materials and may have one or more different properties such as hardness, coefficient of friction, surface texture, color, length, width, and/or mass. The surface treatment head 14 and/or the end interconnector 32 may comprise the same or different material(s) and/or propert(ies).

The first interconnector 30/30A may comprise one or more first materials, and the second interconnector 30B may comprise one or more second materials that are the same as or different from the first material(s). For example, the first interconnector 30/30A and the second interconnector 30B may comprise one or more elastomers, silicones, engineering plastics, and/or metals. The surface treatment head 14, the second interconnector 30C, and/or the end interconnector 32 may comprise the same material(s) or one or more different materials. In some examples, the first interconnector 30/30A may comprise a first material, and the end interconnector 32 may comprise a second material that is different from the first material.

The first interconnector 30/30A may comprise a material with a first hardness, and the second interconnector 30B may comprise a material with a second hardness that is the same as or different from the first hardness. In some examples, the first and/or second interconnectors 30/30A and 30B may comprise a softer material with a shore A hardness of about 20 to 40. In other examples, the first and/or second interconnectors 30/30A and 30B may comprise a harder material with a shore A hardness greater than 50, e.g., from about shore A 60 to about shore D 100.Materials comprising metal may have a shore D hardness of greater than 100. The material(s) comprising the surface treatment head 14, the second interconnector 30C, and/or the end interconnector 32 may have the same hardness or a different hardness. Softer materials may provide a more comfortable and improved gripping surface, while harder materials may provide greater durability and resistance to damage. A number and/or location of the components comprising softer or harder material(s) may be adjusted and customized as desired based on user preference, e.g., a size of the user's hand, how the user grips the handle section 12 and 12′, etc.

The first interconnector 30/30A may comprise a material with a first coefficient of friction (CoF), and the second interconnector 30B may comprise a material with a second CoF that is the same as or different from the first CoF. The material(s) comprising the surface treatment head 14, the second interconnector 30C, and/or the end interconnector 32 may have the same CoF or a different CoF. Materials with a higher CoF may provide a better gripping surface, e.g., within the handle section 12 and 12′, while materials with a lower CoF provide higher glide or slipperiness. A number and/or location of the components comprising a higher or lower CoF may be adjusted and customized as desired based on user preference, e.g., a size of the user's hand, how the user grips the handle section 12 and 12′, etc.

The first interconnector 30/30A may comprise a first surface texture, and the second interconnector 30B may comprise a second surface texture that is the same as or different from the first surface texture. The surface treatment head 14, the second interconnector 30C, and/or the end interconnector 32 may have the same surface texture or a different surface texture. The surface texture may be determined, at least in part, by the material(s) and/or the presence or absence of gripping protrusions 64, 66 and/or other structures that form one or more protrusions or peaks and/or recesses or valleys on a surface of the component. A number and/or location of the components may be adjusted and customized based on the surface texture(s) to obtain a desired feel for the handle section 12 and 12′.

The first interconnector 30/30A may comprise one or more first colors, and the second interconnector 30B may comprise one or more second colors that are the same as or different from the first color(s). The surface treatment head 14, the second interconnector 30C, and the end interconnector 32 may have the same color(s) or one or more different colors. For example, the surface treatment head 14, the first interconnector 30/30A, the second interconnector 30B or 30C, and/or the end interconnector 32 may be selected to include a color combination corresponding to a country flag, a favorite sports team, etc.

The first and second interconnectors 30A, 30B, and 30C may comprise the same length and/or width or a different length and/or width. For example, as shown in FIG. 1B, the first interconnector 30A comprises a first length L₁, and the second interconnector 30B comprises a second length L₂ that is less than the first length L₁. The second interconnector 30C comprises a third length L₃, which may be the same as or different from the first and/or second lengths L₁ and L₂. In some examples, the first, second, and/or third lengths L₁, L₂, and L₃ may each be from 20 mm to 60 mm, and preferably 30 mm to 50 mm. The first and second interconnectors 30A, 30B, and 30C may likewise comprise respective first, second, and third widths W₁, W₂, and W₃, which may be the same or different. In some examples, the first, second, and/or third widths W₁, W₂, and W₃ may each be from 10 mm to 35 mm, and preferably 10 mm to 20 mm. As shown in FIGS. 1A and 1B, an overall length L₄ and L_{4′} of the handle section 12 and 12′ and/or width (not separately labeled) of all or part of the handle section 12 and 12′ may be adjusted and customized by altering a number and/or configuration of the first and second interconnectors 30/30A, 30B, and/or 30C based on user preference, e.g., a size of the user's hand, how the user grips the handle section 12 and 12′, etc. In some examples, the overall length L₄ or L_{4′} of the handle section 12 or 12′ may be 120 mm to 150 mm. In other examples, the overall length L₄ or L_{4′} of the handle section 12 or 12′ may be 600 mm or greater, e.g., for hard-to-reach areas such as the user's back.

The first interconnector 30/30A may comprise a first mass, and the second interconnector 30B may comprise a second mass that is the same as or different from the first mass. The second interconnector 30C may comprise a third mass, which may be the same as or different from the first and/or second masses. The first, second, and third masses may be determined, at least in part, by the material(s) comprising the first and second interconnector(s) 30/30A, 30B, and 30C and the respective lengths L₁, L₂, and L₃ and/or widths W₁, W₂, and W₃. In some examples, the first, second, and/or third masses may each be from 3 g to 50 g or greater. An overall mass of the modular personal care implement 10 and 10′ and/or a distribution or balance of mass within the modular personal care implement 10 and 10′ may be adjusted and customized by altering a number and/or configuration of the first and second interconnectors 30/30A, 30B, and/or 30C. In some examples, the overall mass of the modular personal care implement 10 and 10′ may be about 15 g.

The first interconnector 30/30A may comprise a first cross-sectional shape, and at least a portion of the end interconnector 32 may comprise a second cross-sectional shape that is different from the first cross-sectional shape. For example, as shown in FIGS. 1A, 3, 4A, and 4B, the outer surface 30-1 of the first interconnector 30/30A (excluding the gripping protrusions 64) defines a substantially semicircular or hemispherical cross-sectional shape with a flat portion and a curved portion, in which the shape of the first interconnector 30/30A may be uniform along an entirety of the length L₁ (see FIG. 1B) of the first interconnector 30/30A. As shown in FIGS. 1A, 3, 5A, and 5B, the outer surface 32-1 of the end interconnector 32 near the first end 42 defines a substantially semicircular or hemispherical cross-sectional shape that corresponds to the cross-sectional shape of the first interconnector 30/30A shown in FIGS. 1A, 4A, and 4B. The semicircular/hemispherical cross-sectional shape of the first and second interconnectors 30/30A, 30B, and 30C and the first end 42 of the end interconnector 32 may provide an ergonomic shape that may assist with gripping the modular personal care implement 10 and 10′.

The end interconnector 32 may include a transition section 68 located between the first and second ends 42 and 46, in which the cross-sectional shape of the end interconnector 32 transitions from the substantially semicircular/hemispherical cross-sectional shape near the first end 42 to a substantially circular cross-sectional shape near the second end 46. With reference to FIG. 3, the first end 42 of the end interconnector 32 may also comprise a width W₄ that is identical or substantially similar to the width W₁ of the first interconnector 30/30A. The end interconnector 32 may optionally increase in width along the transition section 68 and toward the second end 46, such that the second end 46 comprises a width W₅ that is greater than the width W₄. As shown in FIGS. 6A, 6B, 7A, and 7B, the outer surfaces 30B-1 and 30C-1 of the second interconnectors 30B and 30C (excluding the gripping protrusions 66 of the second interconnector 30C) define a substantially semicircular or hemispherical cross-sectional shape that is similar to the cross-sectional shape of the first interconnector 30/30A, in which the shape of the second interconnectors 30B and 30C may be uniform along an entirety of the respective lengths L₂ and L₃ (see FIG. 1B) of the second interconnectors 30B and 30C.

As shown in FIG. 12, the modular personal care implement 10/10′ in accordance with the present disclosure may be part of a kit 80 comprising multiple components, including one or more surface treatment heads 14 and 14′, at least one first interconnector 30/30A, at least one second interconnector 30B and/or 30C, and at least one end interconnector 32. In the example shown in FIG. 12, the kit 80 includes a first surface treatment head 14 comprising a shaving razor cartridge 24, a second surface treatment head 14′ comprising a brush head 28, a first interconnector 30/30A, two second interconnectors 30B and 30C, and an end interconnector 32. It may be understood that the kit 80 may include any number or configuration of the components described herein.

The kit 80 may include a case 82 comprising a top portion 84 and a bottom portion 86, in which the bottom portion 86 of the case 82 is configured to removably receive an insert 88 within the bottom portion 86. The insert 88 may comprise one or more cavities 90 configured, i.e., sized and shaped, to receive the components of the kit 80, e.g., the surface treatment head(s) 14 and/or 14′, the first interconnector(s) 30/30A, the second interconnector(s) 30B and/or 30C, and the end interconnector(s) 32. The bottom portion 86 may be configured to be received in the top portion 84 to enclose the kit 80 and the components thereof. The top and bottom portions 84 and 86 may be coupled together by a friction fit, a hinge (not shown), and/or by other means, such as one or more adhesive stickers or labels. The top and bottom portions 84 and 86 of the case 82 may each comprise a durable material such as an engineering plastic (e.g., a polycarbonate), a metal, or a metal alloy (e.g., steel, aluminum, tin, or combinations thereof). The case 82 may provide a sturdy, multi-use container that protects the components of the kit 80. The case 82 may also serve as a durable and convenient storage and travel kit and may be used to hold, organize, and store the components of the modular personal care implement 10/10′ for day-to-day use. The case 82 may comprise a hang tag 92 that may be coupled to the case 82 via adhesive or other suitable attachment means or may be formed as part of the case 82. The hang tag 92 may be removable. The hang tag 92 may be configured to allow the kit 80 to be displayed and/or stored and may comprise an aperture (not labeled) that allows the kit 80 to be associated with a display and/or storage system (not shown) by, for example, hanging the kit 80 from a hook or peg.

The modular personal care implement 10 and 10′ in accordance with the present disclosure provides an ergonomic handle section 12 and 12′ with separable components that allow a user to customize the configuration as desired and to easily replace the components or a portion thereof. With reference to FIGS. 1A, 1B, 2, and 12, the surface treatment heads 14 and 14′, the first interconnector 30/30A, the second interconnectors 30B and 30C, and the end interconnector 32 all include mechanical connections, i.e., threaded connections, that are compatible with each other, such that an overall length L₄ and L_{4′} of the handle section 12 and 12′ may be customized by altering the number and/or configuration of the first and second interconnectors 30/30A, 30B, and/or 30C. For example, the surface treatment head 14 comprising the shaving razor cartridge 24 may be attached to the first interconnector 30/30A, and the first interconnector 30/30A may be attached to the end interconnector 32 to obtain the modular personal care implement 10 depicted in FIG. 1A with the handle section 12 having the length L₄. In the example shown in FIG. 1B, both of the second interconnectors 30B and 30C have been added to obtain the modular personal care implement 10′ with the handle section 12′ having the length L_{4′}, in which the length L_{4′} is greater than the length L₄. In other examples (not shown), the surface treatment head 14 may be, for example, attached directly to the end interconnector 32 to obtain a shorter length. The relative location of the first and second interconnectors 30/30A, 30B, or 30C may also be altered based on the material(s) comprising the outer surfaces 30-1, 30B-1, and 30C-1 thereof. For example, with reference to FIGS. 1B, 2, 4A, 4B, 7A, and 7B, the first interconnector 30/30A comprising the gripping protrusions 64 may be attached to the second interconnector 30C comprising the gripping protrusions 66, so that a middle portion of the handle section 12 and 12′ includes a longer, continuous section of gripping protrusions 64 and 66 (not shown). The number and/or configuration of the first and second interconnectors 30/30A, 30B, and/or 30C may further be altered as desired based on the properties described herein to obtain a desired look and feel for the handle section 12 and 12′.

With reference to FIGS. 1A, 2, and 3, the surface treatment head 14 comprising the shaving razor cartridge 24 may be replaced in its entirety by detaching the first detachable connector 22 from an adjacent component and removably attaching a new surface treatment head 14. Alternatively, only the shaving razor cartridge 24 may be replaced by actuating the actuator button 50 to eject the shaving razor cartridge 24 from the cartridge support structure 56 and attaching a new shaving razor cartridge 24 to the cartridge support structure 56. The surface treatment head 14′ comprising a brush head 28 (see FIG. 12) may be replaced by detaching the first detachable connector 22′ from an adjacent component and removably attaching a new surface treatment head 14′. The first interconnector 30/30A, the second interconnector(s) 30B and 30C, and/or the end interconnector 32 may also be detached and replaced.

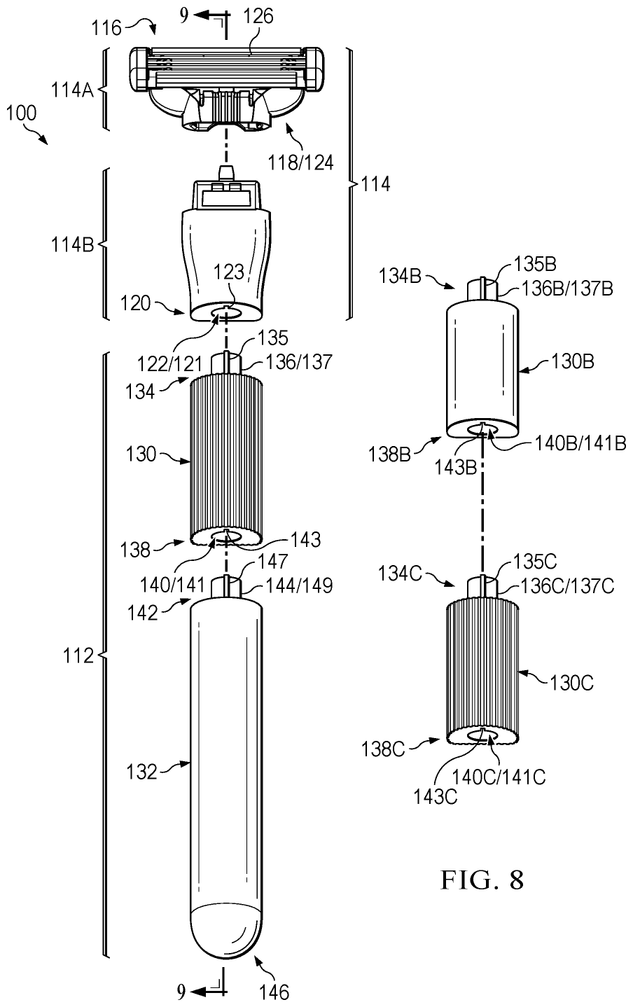

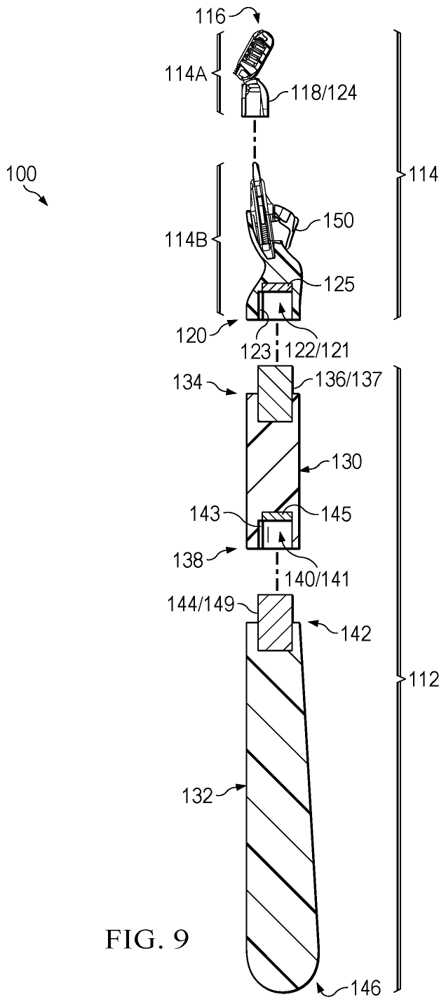

With reference to FIGS. 8 and 9, another example of a modular personal care implement 100 is illustrated. The modular personal care implement 100 comprises a handle section 112 and a surface treatment head 114. The surface treatment head 114 has a first end 116 with an applicator 118, and a second end 120 with a first detachable connector 122. Apart from the first detachable connector 122, the surface treatment head 114 may be substantially similar to the surface treatment head 14 described with respect to FIGS. 1-3 and may comprise a first portion 114A that includes the applicator 118 and a second portion 114B that includes the first detachable connector 122. As described with respect to the modular personal care implement 10 and 10′, the surface treatment head 114 may further comprise a release mechanism, e.g., an actuator button 150, that is configured to eject the first portion 114A comprising the applicator 118 from the second portion 114B comprising the first detachable connector 122. In the example shown in FIG. 8, the surface treatment head 114 comprises a shaving razor cartridge 124, and the applicator 118 comprises at least one blade 126. It may be understood that the surface treatment head 114 may comprise a brush head, as described with respect to FIG. 12.

The handle section 112 comprises a first interconnector 130 and an end interconnector 132. The first interconnector 130 has a first end 134 with a second detachable connector 136, and a second end 138 with a third detachable connector 140. The end interconnector 132 has a first end 142 with a fourth detachable connector 144. Apart from the respective detachable connectors 136, 140, and 144, the first interconnector 130 and the end interconnector 132 may be substantially similar to the first interconnector 30/30A and the end interconnector 32 described with respect to FIGS. 1-7 and 12. The second detachable connector 136 of the first interconnector 130 may be securely and removably attached to the first detachable connector 122 of the surface treatment head 114 to removably attach the surface treatment head 114 to the first interconnector 130. The fourth detachable connector 144 of the end interconnector 132 may be securely and removably attached to the third detachable connector 140 of the first interconnector 130 to removably attach the first interconnector 130 to the end interconnector 132, as described herein, to form a structure similar to the modular personal care implement 10 depicted in FIG. 1A. A second end 146 of the end interconnector 132 may define a terminus or terminal end of the handle section 112.

The modular personal care implement 100 of FIG. 8 may optionally further comprise at least one second interconnector 130B and/or 130C. The second interconnectors 130B and 130C each have a respective first end 134B and 134C with a detachable connector 136B and 136C and a respective second end 138B and 138C with a detachable connector 140B and 140C. In the example shown in FIG. 8, the third detachable connector 140 of the first interconnector 130 may be removably attached to the detachable connector 136B at the first end 134B of the second interconnector 130B; the detachable connector 140B at the second end 138B of the second interconnector 130B may be removably attached to the detachable connector 136C at the first end 134C of the second interconnector 130C; and the detachable connector 140C at the second end 138C of the second interconnector 130C may be removably attached to the fourth detachable connector 144 of the end interconnector 132, with the second end 146 of the end interconnector 132 defining a terminus or terminal end of the handle section 112. While the illustrated example includes two second interconnectors 130A and 130B, it may be understood that the modular personal care implement 100 may include one second interconnector, three second interconnectors, four second interconnectors, etc. Apart from the respective detachable connectors 136B, 136C, 140B, and 140C, the second interconnector(s) 130B and 130C may be substantially similar to the second interconnector(s) 30B and 30C described with respect to FIGS. 1-7 and 12.

With continued reference to FIGS. 8 and 9, the first detachable connector 122 of the surface treatment head 114, the second and third detachable connectors 136 and 140 of the first interconnector 130, the detachable connectors 136B, 136C, 140B, 140C of the second interconnectors 230B and 230C, and the fourth detachable connector 144 of the end interconnector 132 each comprise a magnetic connection. The first detachable connector 122 of the surface treatment head 114 may comprise a cavity 121 comprising a notch 123 and a magnetic material, e.g., a magnet 125, and the second detachable connector 136 of the first interconnector 130 may comprise a ridge 135 and a post 137 comprised of or comprising a magnetic material. The cavity 121 and notch 123 of the first detachable connector 122 are configured to receive the post 137 and ridge 135, respectively, of the second detachable connector 136 of the first interconnector 130. The magnetic materials each produce a magnetic field, in which the magnetic material of the post 137 is attracted to the magnetic material of the cavity 121 to create the magnetic connection and securely and removably attach the first detachable connector 122 to the first interconnector 130 to attach the surface treatment head 114 to the first interconnector 130. Engagement between the notch 123 and the ridge 135 helps to align the surface treatment head 114 with respect to the first interconnector 130.

The third detachable connector 140 of the first interconnector 130 may comprise a cavity 141 comprising a notch 143 and a magnetic material, e.g., a magnet 145, and the fourth detachable connector 144 of the end interconnector 132 may comprise a ridge 147 and a post 149 comprised of or comprising a magnetic material. The cavity 141 and notch 143 are configured to receive the post 149 and ridge 147, respectively, and the magnetic materials of the cavity 141 and the post 149 are attracted to each other to create the magnetic connection that removably attaches the first interconnector 130 to the end interconnector 132 to attach the first interconnector 130 to the end interconnector 132. Engagement between the notch 143 and the ridge 147 helps to align the end interconnector 132 with respect to the first interconnector 130. The detachable connectors 136B and 136C at the first ends 134B and 134C of the second interconnectors 130B and 130C each comprise a respective ridge 135B and 135C and post 137B and 137C comprised of or comprising a magnetic material (not shown). The detachable connectors 140B and 140C at the second ends 138B and 138C of the second interconnectors 130B and 130C each comprise a respective cavity 141B and 141C comprising a respective notch 143B and 143C and magnetic material (not shown). The detachable connectors 136B, 136C, 140B, and 140C may be removably, i.e., magnetically, connected or attached as described herein with respect to the detachable connectors 122, 136, 140, and/or 144 of an adjacent component, i.e., the surface treatment head 114, the first interconnector 130, or the end interconnector 132. The surface treatment head 114, the first interconnector 130, the second interconnector(s) 130B and 130C, and/or the end interconnector 132 may be detached by pulling one component away from the adjacent component along a longitudinal axis (not labeled) of the handle section 112 with a force sufficient to break the magnetic connection between adjacent components.

The modular personal care implement 100 may be part of a kit (not shown) comprising multiple components, including one or more surface treatment heads 114, at least one first interconnector 130, at least one second interconnector 130B and/or 130C, and at least one end interconnector 132. The kit comprising the modular personal care implement 100 may be substantially similar to the kit 80 described with respect to FIG. 12. As described with respect to the modular personal care implement 10 and 10′, the modular personal care implement 100 provides an ergonomic handle section 112 that allows a user to customize the configuration as desired, e.g., to adjust a number and/or configuration of the components to obtain a desired length and/or width (not labeled) of the handle section 112 and/or to adjust the number and/or configuration of the components based on hardness, coefficient of friction, surface texture, color, and/or mass to obtain a desired look and feel for the handle section 112. The surface treatment head(s) 114, the first interconnector(s) 130, the second interconnector(s) 130B and/or 130C, and/or the end interconnector(s) 132 may also be easily replaced, as described herein.

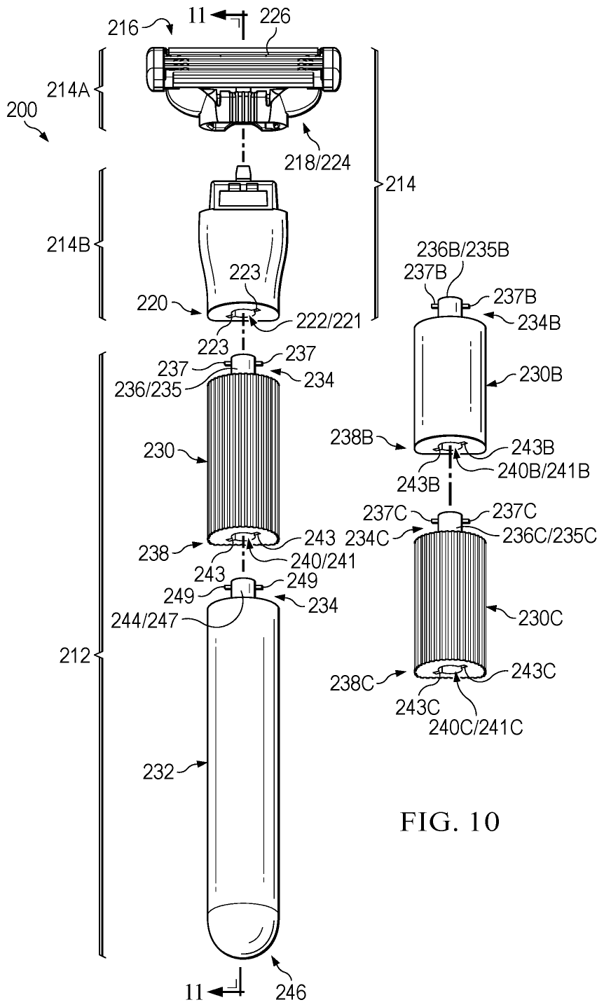

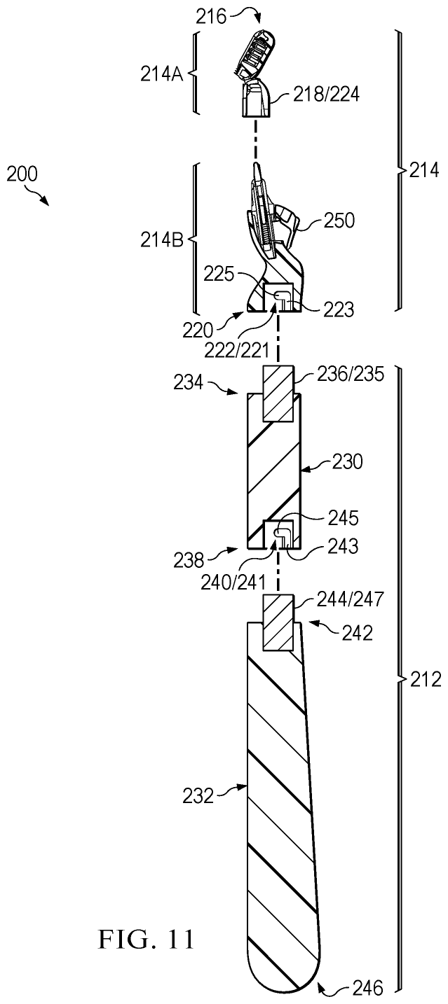

With reference to FIGS. 10 and 11, another example of a modular personal care implement 200 is illustrated. The modular personal care implement 200 comprises a handle section 212 and a surface treatment head 214. The surface treatment head 214 has a first end 216 with an applicator 218, and a second end 220 with a first detachable connector 222. Apart from the first detachable connector 222, the surface treatment head 214 may be substantially similar to the surface treatment head 14 described with respect to FIGS. 1-3. The surface treatment head 214 may comprise a first portion 214A that includes the applicator 218 and a second portion 214B that includes the first detachable connector 222. As described with respect to the modular personal care implement 10 and 10′, the surface treatment head 214 may further comprise a release mechanism, e.g., an actuator button 250, that is configured to eject the first portion 214A comprising the applicator 218 from the second portion 214B comprising the first detachable connector 222. In the example shown in FIG. 10, the surface treatment head 214 comprises a shaving razor cartridge 224, and the applicator 218 comprises at least one blade 226. It may be understood that the surface treatment head 214 may comprise a brush head, as described with respect to FIG. 12.

The handle section 212 comprises a first interconnector 230 and an end interconnector 232. The first interconnector 230 has a first end 234 with a second detachable connector 236, and a second end 238 with a third detachable connector 240. The end interconnector 232 has a first end 242 with a fourth detachable connector 244. Apart from the respective detachable connectors 236, 240, and 244, the first interconnector 230 and the end interconnector 232 may be substantially similar to the first interconnector 30/30A and the end interconnector 32 described with respect to FIGS. 1-7 and 12. The second detachable connector 236 of the first interconnector 230 may be securely and removably attached to the first detachable connector 222 of the surface treatment head 214 to removably attach the surface treatment head 214 to the first interconnector 230. The fourth detachable connector 244 of the end interconnector 232 may be removably attached to the third detachable connector 240 of the first interconnector 230 to removably attach the first interconnector 230 to the end interconnector 232, as described herein, to form a structure similar to the modular personal care implement 10 depicted in FIG. 1A. A second end 246 of the end interconnector 232 may define a terminus or terminal end of the handle section 212.

The modular personal care implement 200 of FIG. 10 may optionally further comprise at least one second interconnector 230B and/or 230C. The second interconnectors 230B and 230C each have a respective first end 234B and 234C with a detachable connector 236B and 236C and a respective second end 238B and 238C with a detachable connector 240B and 240C. In the example shown in FIG. 10, the third detachable connector 240A of the first interconnector 230 may be removably attached to the detachable connector 236B at the first end 234B of the second interconnector 230B; the detachable connector 240B at the second end 238B of the second interconnector 230B may be removably attached to the detachable connector 236C at the first end 234C of the second interconnector 230C; and the detachable connector 240C at the second end 238C of the second interconnector 230C may be removably attached to the fourth detachable connector 244 of the end interconnector 232, with the second end 246 of the end interconnector 232 defining a terminus or terminal end of the handle section 212. While the illustrated example includes two second interconnectors 230A and 230B, it may be understood that the modular personal care implement 200 may include one second interconnector, three second interconnectors, four second interconnectors, etc. Apart from the detachable connectors 236B, 236C, 240B, and 240C, the second interconnector(s) 230B and 230C may be substantially similar to the second interconnector(s) 30B and 30C described with respect to FIGS. 1-7 and 12.

With continued reference to FIGS. 10 and 11, the first detachable connector 222 of the surface treatment head 214, the second and third detachable connectors 236 and 240 of the first interconnector 230, the detachable connectors 236B, 236C, 240B, 240C of the second interconnectors 230B and 230C, and the fourth detachable connector 244 of the end interconnector 232 each comprise a mechanical connection in the form of a bayonet connection. The first detachable connector 222 of the surface treatment head 214 carries a female portion of the bayonet connection comprising a cavity 221 with a pair of slots 223 (only one slot 223 is visible in FIG. 11). The second detachable connector 236 of the first interconnector 230 carries a male portion of the bayonet connection comprising a barrel 235 and a pair of protrusions 237 formed on the barrel 235. The cavity 221 and slots 223 of the first detachable connector 222 are configured to receive the barrel 235 and protrusions 237, respectively, of the second detachable connector 236. For example, the surface treatment head 214 may be attached to the first interconnector 230 by aligning the protrusions 237 with the slots 223, inserting the barrel 235 and protrusions 237 into the cavity 221, and twisting the surface treatment head 214 and/or the first interconnector 230 about a longitudinal axis (not labeled) of the handle section 212, such that each protrusion 237 is received in a detent area 225 provided at the end of each slot 223 (only one detent area 225 is visible in FIG. 11). The engagement of the protrusions 237 in the detent areas 225 aligns the surface treatment head 214 with respect to the first interconnector 230 and provides a secure, twist-on mechanical connection of the surface treatment head 214 to the first interconnector 230. The surface treatment head 214 may be detached from the first interconnector 230 by twisting the surface treatment head 214 and/or the first interconnector 230 about the longitudinal axis in an opposite direction to disengage the protrusions 237 from the detent areas 225 and pulling the surface treatment head 214 and the first interconnector 230 apart.

The third detachable connector 240 of the first interconnector 230 carries a female portion of the bayonet connection comprising a cavity 241 with a pair of slots 243 (only one slot 243 is visible in FIG. 11). The fourth detachable connector 244 of the end interconnector 232 carries a male portion of the bayonet connection comprising a barrel 247 and a pair of protrusions 249 formed on the barrel 247. As described with respect to the corresponding structures of the first and second detachable connectors 222 and 236, the cavity 241 and slots 243 of the third detachable connector 240 are configured to receive the barrel 247 and protrusions 249, respectively, of the fourth detachable connector 244. The protrusions 249 are received and retained in detent areas 245 provided at the end of each slot 243 (only one detent area 245 is visible in FIG. 11) to align the first interconnector 230 with respect to the end interconnector 232 and provide a secure, twist-on and twist-off mechanical connection of the first interconnector 230 to the end interconnector 232.

The detachable connectors 236B and 236C at the first ends 234B and 234C of the second interconnectors 230B and 230C each carry a male portion of the bayonet connection comprising a respective barrel 235B and 235C and pair of protrusions 237B and 237C formed on the barrel 235B and 235C. The detachable connectors 240B and 240C at the second ends 238B and 238C of the second interconnectors 230B and 230C each carry a female portion of the bayonet connection comprising a respective cavity 241B and 241C comprising respective slots 243B and 243C with detent areas (not visible). The detachable connectors 236B, 236C, 240B, and 240C may be removably attached, i.e., via the bayonet connection, as described herein to corresponding ones of the detachable connectors 222, 236, 240, and/or 244 of the surface treatment head 214, the first interconnector 230, and/or the end interconnector 232.

The modular personal care implement 200 may be part of a kit (not shown) comprising multiple components, including one or more surface treatment heads 214, at least one first interconnector 230, at least one second interconnector 230B and/or 230C, and at least one end interconnector 232. The kit comprising the modular personal care implement 200 may be substantially similar to the kit 80 described with respect to FIG. 12. As described with respect to the modular personal care implement 10 and 10′, the modular personal care implement 200 provides an ergonomic handle section 212 that allows a user to customize the configuration as desired, e.g., to adjust a number and/or configuration of the components to obtain a desired length and/or width (not labeled) of the handle section 212 and/or to adjust the number and/or configuration of the components based on hardness, coefficient of friction, surface texture, color, and/or mass to obtain a desired look and feel for the handle section 212. The surface treatment head(s) 214, the first interconnector(s) 230, the second interconnector(s) 230B and/or 230C, and the end interconnector(s) 232 may also be easily replaced, as described herein.

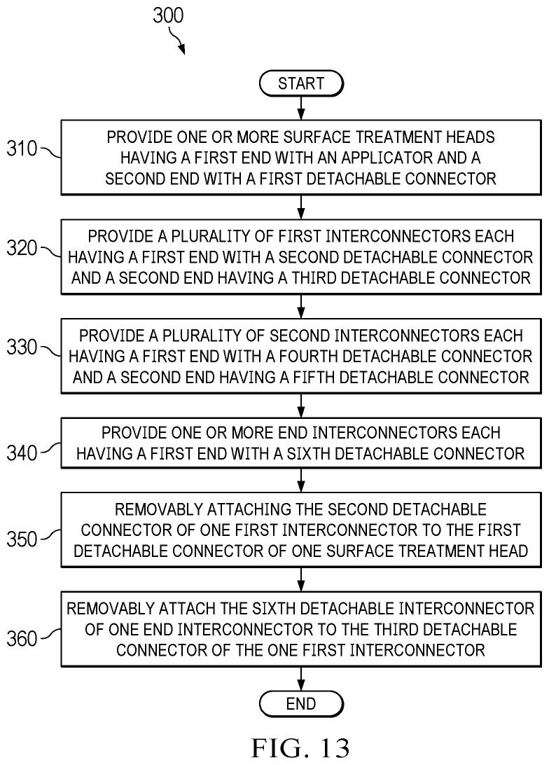

FIG. 13 is a flow diagram of a method 300 of providing a modular personal care implement, in accordance with the present disclosure. As shown in FIG. 13, the method 300 includes providing one or more surface treatment heads having a first end with an applicator and a second end with a first detachable connector at 310; providing a plurality of first interconnectors each having a first end with a second detachable connector and a second end having a third detachable connector at 320; providing a plurality of second interconnectors each having a first end with a fourth detachable connector and a second end having a fifth detachable connector at 330; and providing one or more end interconnectors each having a first end with a sixth detachable connector at 340. The method 300 further includes removably attaching the second detachable connector of one first interconnector of the plurality of first interconnectors to the first detachable connector of one surface treatment head of the one or more surface treatment heads at 350. The method 300 may further include removably attaching the sixth detachable interconnector of one of the one or more end interconnectors to the third detachable connector of the one first interconnector at 360, after which the method 300 may conclude.

The method 300 may optionally include removably attaching the fourth detachable connector of one second interconnector of the plurality of second interconnectors to the third detachable connector of the one first interconnector, and removably attaching the sixth detachable interconnector of one of the one or more end interconnectors to the fifth detachable connector of the one second interconnector. In some examples, the one or more surface treatment heads may each further comprise a release mechanism positioned between the first and second end of the surface treatment head, and the method may further include actuating the release mechanism to eject a portion of the one surface treatment head comprising the applicator.

The modular personal care implement formed by the method 300 may include any of the modular personal care implements 10, 10′, 100, and 200 described herein, in which the first detachable connector of the one or more surface treatment heads, the second and third detachable connectors of the plurality of first interconnectors, the fourth and fifth detachable connectors of the plurality of second interconnectors, and the sixth detachable connector of the one or more end interconnectors may comprise a mechanical connection, i.e., a bayonet connection or a threaded connection, or a magnetic connection.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests, or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A modular personal care implement comprising:
a surface treatment head having a first end with an applicator and a second end with a first detachable connector; and
a first interconnector having a first end with a second detachable connector and a second end with a third detachable connector, wherein the second detachable connector is removably attached to the first detachable connector of the surface treatment head.

2. The modular personal care implement of claim 1, wherein the first detachable connector of the surface treatment head and the second detachable connector of the first interconnector comprise a mechanical connection or a magnetic connection.

3. The modular personal care implement of claim 1, further comprising:
an end interconnector having a first end with a fourth detachable connector, wherein the fourth detachable connector is removably attached to the third detachable connector of the first interconnector.

4. The modular personal care implement of claim 3, wherein the first detachable connector of the surface treatment head, the second and third detachable connectors of the first interconnector, and the fourth detachable connector of the end interconnector comprise a mechanical connection or a magnetic connection.

5. The modular personal care implement of claim 3, wherein the first interconnector comprises a first cross-sectional shape and at least a portion of the end interconnector comprises a second cross-sectional shape that is different from the first cross-sectional shape.

6. The modular personal care implement of claim 3, wherein the first interconnector comprises a first material and the end interconnector comprises a second material that is different from the first material.

7. The modular personal care implement of claim 3, wherein an outer surface of the first interconnector comprises a plurality of gripping protrusions and an outer surface of the end interconnector is smooth.

8. The modular personal care implement of claim 1, further comprising:
at least one second interconnector having a first end with a fourth detachable connector and a second end with a fifth detachable connector, wherein the fourth detachable connector is removably attached to the third detachable connector of the first interconnector; and
an end interconnector having a first end with a sixth detachable connector, wherein the sixth detachable connector is removably attached to the fifth detachable connector of the at least one second interconnector.

9. The modular personal care implement of claim 8, wherein the first detachable connector of the surface treatment head, the second and third detachable connectors of the first interconnector, the fourth and fifth detachable connectors of the at least one second interconnector, and the sixth detachable connector of the end interconnector comprise a mechanical connection or a magnetic connection.

10. The modular personal care implement of claim 8, wherein the first interconnector comprises a first length, a first width, a first material, a first mass, a first hardness, and a first color and the at least one second interconnector comprises a second length, a second width, a second material, a second mass, a second hardness, and a second color, and wherein at least one of the second length, second width, second material, second mass, second hardness, or second color is different from a corresponding one of the first length, first width, first material, first mass, first hardness, or first color.

11. The modular personal care implement of claim 1, wherein the surface treatment head comprises a shaving razor cartridge and the applicator comprises at least one blade.

12. The modular personal care implement of claim 1, wherein the surface treatment head comprises a brush head and the applicator comprises a plurality of bristles.

13. The modular personal care implement of claim 1, wherein the surface treatment head further comprises a release mechanism positioned between the first and second end of the surface treatment head, the release mechanism comprising an actuator button configured to eject a portion of the surface treatment head comprising the applicator.

14. A method of providing a modular personal care implement, the method comprising:
providing one or more surface treatment heads each having a first end with an applicator and a second end with a first detachable connector;
providing a plurality of first interconnectors each having a first end with a second detachable connector and a second end with a third detachable connector;
providing a plurality of second interconnectors each having a first end with a fourth detachable connector and a second end with a fifth detachable connector;
providing one or more end interconnectors each having a first end with a sixth detachable connector; and
removably attaching the second detachable connector of one first interconnector of the plurality of first interconnectors to the first detachable connector of one surface treatment head of the one or more surface treatment heads.

15. The method of claim 14, further comprising:
removably attaching the sixth detachable interconnector of one of the one or more end interconnectors to the third detachable connector of the one first interconnector.

16. The method of claim 14, further comprising:
removably attaching the fourth detachable connector of one second interconnector of the plurality of second interconnectors to the third detachable connector of the one first interconnector; and
removably attaching the sixth detachable interconnector of one of the one or more end interconnectors to the fifth detachable connector of the one second interconnector.

17. The method of claim 14, wherein the first detachable connector of the one or more surface treatment heads, the second and third detachable connectors of the plurality of first interconnectors, the fourth and fifth detachable connectors of the plurality of second interconnectors, and the sixth detachable connector of the one or more end interconnectors comprise a mechanical connection or a magnetic connection.

18. The method of claim 14, wherein the one or more surface treatment heads each further comprise a release mechanism positioned between the first and second end of the surface treatment head, the method further comprising:
actuating the release mechanism to eject a portion of the one surface treatment head comprising the applicator.

19. A kit comprising:
a first surface treatment head comprising a shaving razor cartridge, the first surface treatment head having a first end with an applicator and a second end with a first detachable connector, wherein the applicator comprises at least one blade;
at least one first interconnector having a first end with a second detachable connector and a second end with a third detachable connector;
at least one end interconnector having a first end with a fourth detachable connector;
a case comprising a top portion and a bottom portion; and
an insert comprising one or more cavities configured to receive the first surface treatment head, first interconnector, and end interconnector, wherein the bottom portion of the case defines a compartment configured to removably receive the insert within the bottom portion.

20. The kit of claim 19, further comprising:
a second surface treatment head comprising a brush head, the second surface treatment head having a first end with an applicator and a second end with a first detachable connector, wherein the applicator comprises a plurality of bristles; and
at least one second interconnector having a first end with a fifth detachable connector and a second end with a sixth detachable connector,
wherein the insert further comprises one or more cavities configured to receive the second surface treatment head and the at least one second interconnector.
